(19) United States
(12) Patent Application Publication
(10) Pub. No.: US 2008/0258548 A1
(43) Pub. Date: Oct. 23, 2008

(54) AIRCRAFT BRAKE CONTROL ARCHITECTURE HAVING IMPROVED ANTISKID REDUNDANCY

(76) Inventors: Bill May, Tipp City, OH (US); Henry Grant, Port Henry, NY (US)

Correspondence Address: DON W. BULSON (GRCO);RENNER, OTTO, BOISSELLE & SKLAR, LLP, 1621 EUCLID AVENUE, 19TH FLOOR, CLEVELAND, OH, 44115, US

(21) Appl. No.: 11/736,601

(22) Filed: Apr. 18, 2007

(51) Int. Cl. B60T 8/171; B64C 25/42; B60T 8/32

(52) U.S. Cl. 303/139; 701/71; 244/111

(57) ABSTRACT

According to the present invention, an electromechanical braking system is provided. The braking system includes at least one brake system control unit (BSCU) for converting an input brake command signal into a brake clamp force command signal. In addition, the braking system includes a first electromechanical actuator controller (EMAC) and a second electromechanical actuator controller (EMAC) configured to receive the brake clamp force command signal from the at least one BSCU and to convert the brake clamp force command signal to at least one electromechanical actuator drive control signal. Further, the braking system includes at least one electromechanical actuator configured to receive the at least one drive control signal and to apply a brake clamp force to at least one wheel to be braked in response to the at least one drive control signal. Moreover, the first EMAC and the second EMAC are configured to perform antiskid control in relation to the at least one wheel to be braked.

### TECHNICAL FIELD

The present invention relates generally to brake systems for vehicles, and more particularly to an electromechanical braking system for use in aircraft.

### BACKGROUND OF THE INVENTION

Various types of braking systems are known. For example, hydraulic, pneumatic and electromechanical braking systems have been developed for different applications.

An aircraft presents a unique set of operational and safety issues. As an example, uncommanded braking due to failure can be catastrophic to an aircraft during takeoff. On the other hand, it is similarly necessary to have virtually fail-proof braking available when needed (e.g., during landing).

If one or more engines fail on an aircraft, it is quite possible that there will be a complete or partial loss of electrical power. In the case of an electromechanical braking system, loss of electrical power, failure of one or more system components, etc. raises the question as to whether and how adequate braking may be maintained. It is critical, for example, that braking be available during an emergency landing even in the event of a system failure.

In order to address such issues, various levels of redundancy have been introduced into aircraft brake control architectures. In the case of electromechanical braking systems, redundant powers sources, brake system controllers, electromechanical actuator controllers, etc. have been utilized in order to provide satisfactory braking even in the event of a system failure. For example, U.S. Pat. Nos. 6,296,325 and 6,402,259 describe aircraft brake control architectures providing various levels of redundancy in an electromechanical braking system to ensure satisfactory braking despite a system failure.

Nevertheless, it is still desirable to continue to improve the level of braking available in electromechanical braking systems even in the event of a system failure. As an example, in the past the level of antiskid control available during a system failure could be substantially reduced. Thus, it is desirable to have a brake control system architecture that provides improved antiskid control despite a power failure, system component failure, etc., as compared with conventional electromechanical braking systems.

### SUMMARY OF THE INVENTION

According to the present invention, an electromechanical braking system is provided. The braking system includes at least one brake system control unit (BSCU) for converting an input brake command signal into a brake clamp force command signal. In addition, the braking system includes a first electromechanical actuator controller (EMAC) and a second electromechanical actuator controller (EMAC) configured to receive the brake clamp force command signal from the at least one BSCU and to convert the brake clamp force command signal to at least one electromechanical actuator drive control signal. Further, the braking system includes at least one electromechanical actuator configured to receive the at least one drive control signal and to apply a brake clamp force to at least one wheel to be braked in response to the at least one drive control signal. Moreover, the first EMAC and the second EMAC are configured to perform antiskid control in relation to the at least one wheel to be braked.

In accordance with one aspect, the at least one wheel to be braked includes a first pair of wheels and a second pair of wheels, the first EMAC is configured to provide brake control and antiskid control to a first wheel in each of the first and second pairs of wheels, and the second EMAC is configured to provide brake control and antiskid control to a second wheel in each of the first and second pairs of wheels.

According to another aspect, the first pair of wheels represents a left set of wheels on an aircraft, and the second pair of wheels represents a right set of wheels on the aircraft.

In yet another aspect, at least one sensor is provided for measuring wheel speed of the at least one wheel to be braked, and an output of the at least one sensor is provided to at least one of the first EMAC and the second EMAC independent of the at least one BSCU for purposes of performing the antiskid control.

According to still another aspect, the first EMAC and the second EMAC each include internal redundancy for providing brake control and antiskid control.

With still another aspect, the at least one wheel to be braked includes a first pair of wheels and a second pair of wheels, the first EMAC is configured to provide brake control and antiskid control to a first wheel in each of the first and second pairs of wheels, and the second EMAC is configured to provide brake control and antiskid control to a second wheel in each of the first and second pairs of wheels. A primary channel within the first EMAC controls a first set of actuators on each of the first wheels in the first and second pairs of wheels, an alternate channel within the first EMAC controls a second set of actuators on each of the first wheels in the first and second pairs of wheels, a primary channel within the second EMAC controls a first set of actuators on each of the second wheels in the first and second pairs of wheels, and an alternate channel within the second EMAC controls a second set of actuators on each of the second wheels in the first and second pairs of wheels.

According to another aspect, the first EMAC and the second EMAC receive power from independent power sources.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 is a block diagram of an aircraft brake control architecture in accordance with an exemplary embodiment of the present invention.

### DETAILED DESCRIPTION OF THE INVENTION

The present invention will now be described with reference to the drawing, in which like reference labels are used to refer to like elements throughout.

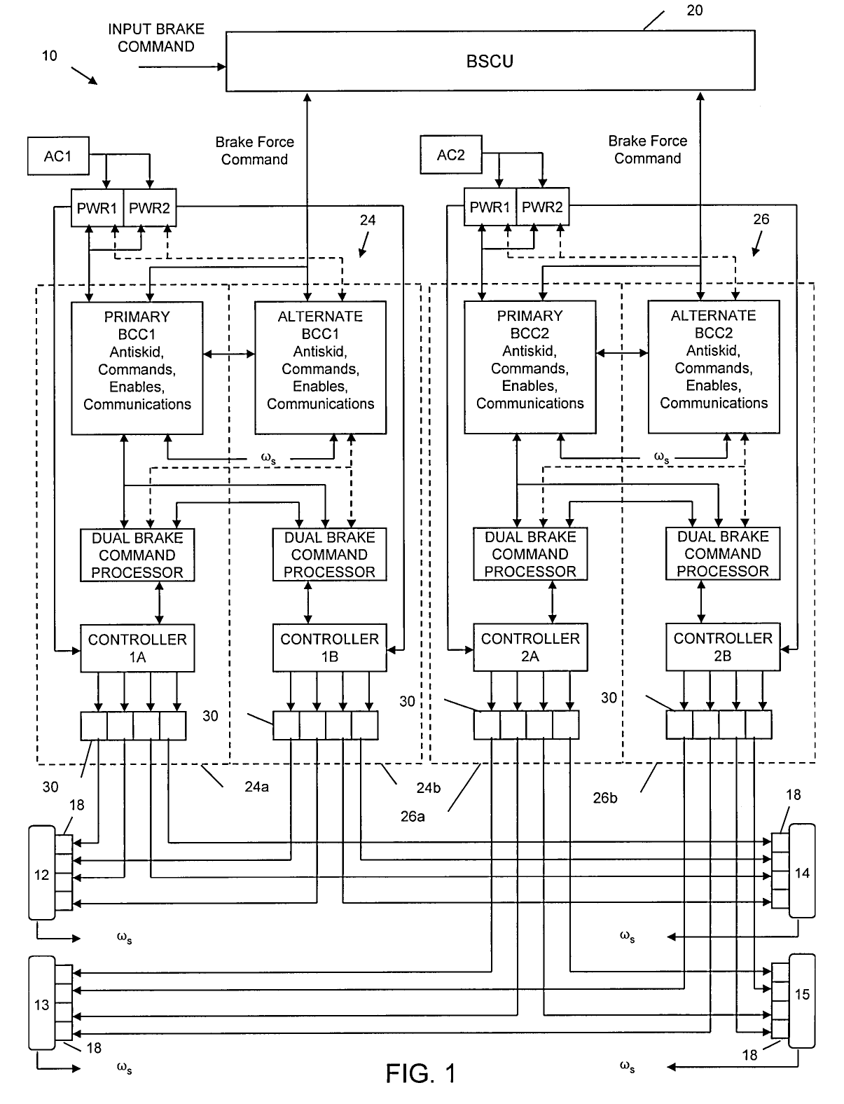

Referring to FIG. 1, a braking system 10 for an aircraft is shown in accordance with the invention. The braking system 10 is shown as providing braking with respect to four wheels 12-15 each having four independent actuators 18. Wheels 12 and 13 represent a first wheel pair corresponding to a left side of the aircraft. Similarly, wheels 14 and 15 represent a second wheel pair corresponding to the right side of the aircraft. It will be appreciated, however, that the present invention may be utilized with essentially any number of wheels, actuators per wheel, etc.

The braking system 10 includes an upper level controller 20, or brake system control unit (BSCU), for providing overall control of the system 10. Such BSCU controller may be in accordance with any conventional method such as that described in the aforementioned U.S. Pat. Nos. 6,296,325 and 6,402,259.

The controller 20 receives as an input an input brake command indicative of the desired amount of braking. For example, the input brake command is derived from the brake pedals within the cockpit of the aircraft, the input brake command indicating the degree to which the brake pedals are depressed, and hence the desired amount of braking. Based on such input, the controller 20 to provide a brake clamp force command signal intended to provide the desired amount of braking in relation to the input brake command.

The braking system 10 further includes first and second EMACs 24 and 26, respectively. The EMACs 24 and 26 each receive the brake clamp force command signal from the controller 20.

The EMAC 24 comprises a primary control channel 24a and an alternate control channel 24b for providing electromechanical actuator drive control signals to wheels 12 and 14. Referring to primary control channel 24a, a primary brake control controller (BCC1) receives the brake clamp force command signal from the controller 20. In accordance with the present invention, the primary BCC1 performs conventional brake control in the sense that the primary BCC1 computes an electromechanical actuator drive control signal in response to the brake clamp force command signal. The primary BCC1 outputs the drive control signal to a dual brake command processor that processes drive control signals as provided by the primary and secondary control channels. Under normal operating conditions, the dual brake command processor of the primary control channel 24a outputs the drive control signal from primary BCC1 to a primary channel controller 1A, which in turn provides corresponding drive control signals to each of the drivers 30 for corresponding actuators 18 of the wheels 12 and 14 to be braked.

The primary BCC1 also outputs an electromechanical actuator drive control signal to a dual brake command processor included in the alternate control channel 24b. The dual brake command processor of the alternate control channel 24b is designed such that under normal operating conditions the computed drive control signal from the primary BCC1 is also provided to controller 1B. The drive control signal is in turn provided to the drivers 30 and the corresponding actuators 18 of the wheels 12 and 14 to be braked. Should the primary BCC1 fail due to power failure, system component failure, etc., the dual brake command processor of the alternate control channel 24b is designed to provide the computed drive control signal from the redundant alternate BCC1 to the controller 1B such that full brake control is maintained.

The alternate control channel 24b is configured similarly to the primary control channel 24a so as to provide redundant control within the EMAC 24. The alternate control channel 24b includes an alternate brake control controller (BCC1) that also receives the brake clamp force command signal from the controller 20. The alternate BCC1 also is configured to perform conventional brake control in the same manner as the primary BCC1 in that the alternate BCC1 computes an electromechanical actuator drive control signal in response to the brake clamp force command signal. The alternate BCC1 outputs the drive control signal to the corresponding dual brake command processor in the alternate control channel 24b as well as the dual brake command processor in the primary control channel 24a which process the redundant drive control signals as provided by the primary and secondary control channel BCC1s in an analogous manner to that described above.

The EMAC 26 is similar to EMAC 24 in that EMAC 26 also includes a primary control channel 26a and an alternate control channel 26b. The EMAC 26 and corresponding BCC2s, dual brake command processors, controllers 2A and 2B, and drivers 30 control a different set of corresponding actuators 18 of the wheels 13 and 15 to be braked.

According to the present invention, the EMACs 24 and 26 are configured also to perform antiskid control for the wheels 12-15. Unlike conventional systems in which antiskid control is performed within the BSCU(s), the EMACs 24 and 26 themselves perform antiskid control. Moreover, the EMACs 24 and 26 perform such antiskid control in such a manner as to avoid competing antiskid control for a given wheel even in the case of EMACs having redundancy as is explained more fully below.

Specifically, in one embodiment of the invention the primary BCCs and alternate BCCs of the EMACs 24 and 26 receive the corresponding wheel speed measurements (ωₛ) of the corresponding wheels controlled by the particular EMAC. Based on such feedback, the EMACs 24 and 26 employ any of a variety of conventional antiskid control algorithms in order to provide appropriate antiskid control of the wheels being braked. Conventionally such antiskid control is carried out within the BSCU(s) as noted above. However, in the present invention the EMACs carry out such antiskid control, thereby reducing the feedback loop providing improved response times, etc. In the preferred embodiment, the measured wheel speed is provided directly to the corresponding EMACs, reducing response lag, cable length, cost, etc.

During normal operation of a given EMAC (e.g., EMAC 24), the primary BCC1 and the alternate BCC1 each receive the brake clamp force command signal from the controller 20. The primary BCC1 and the alternate BCC1 are configured to communicate with one another using conventionally known various self-diagnostics, cross-diagnostics, etc. to determine whether either the primary BCC1 or the alternate BCC1 has failed. Provided the primary BCC1 is functioning properly, the primary BCC1 determines the corresponding electromechanical actuator drive control signal based on the brake clamp force command signal and provides such signal to the respective dual brake command processors. In the meantime, the alternate BCC1 remains inactive.

The primary BCC1 provides conventional brake control as well as the aforementioned antiskid control, and outputs the drive control signal to the dual brake command processors. In addition, the dual brake command processors of the primary and alternate control channels communicate with each other similar to the primary BCC1 and the alternate BCC1 to determine whether either dual brake command processor has failed. As stated above, provided the system 10 is operating normally (i.e., without system failure), the dual brake command processor of the primary control channel 24a provides the drive control signal from the primary BCC1 to the controller 1A. In addition, the primary BCC1 outputs the drive control signal to the dual brake command processor of the alternate control channel 24b. The dual brake command processor of the alternate control channel 24b in turn provides the drive control signal to the controller 1B of the alternate control channel 24b. The controllers 1A and 1B in turn provide the drive control signal to each of their corresponding actuators 18 via the drivers 30 in order to provide the appropriate braking to the wheels.

In the event the primary BCC1 was to fail (e.g., via component failure, loss of power, etc.), the alternate BCC1 would detect such failure. Consequently, in place of the primary BCC1 the alternate BCC1 would become active and provide the drive control signal with appropriate brake control and antiskid control based on the brake clamp force command signal from the controller 20. The alternate BCC1 would thus provide the corresponding electromechanical actuator drive control signal to each of the dual brake command processors (as represented in dashed line). The dual brake command processors would in turn detect operation based on the alternate BCC1 and provide the drive control signal therefrom to the controllers 1A and 1B so as again to effect appropriate braking.

Should one of the primary and alternate dual brake command processors fail, such occurrence is detected among the dual brake command processors via conventional diagnostics. In such case, the healthy dual brake command processor receives the drive control signal from the primary or alternate BCC1 (whichever is active at the time). The healthy dual command processor in turn provides the drive control signal to its corresponding controller (e.g., 1A or 1B) such that the drive control signal is provided to the actuators 18 associated with the dual command processor of that particular channel. In addition, the healthy dual brake command processor is configured to provide the drive control signal to the controller 1A or 1B associated with the failed dual brake command processor. This may be accomplished via hard wiring through the failed dual brake command processor upon the failure of such processor as represented in FIG. 1.

Operation of the EMAC 26 is similar to that of EMAC 24 with the exception that the EMAC 26 controls a different set of actuators for wheels 13 and 15. Accordingly, further detail has been omitted herein as being redundant.

According to the exemplary embodiment, the aircraft has two independent power sources AC1 and AC2. The power source AC1 provides power to power supply channels PWR1 and PWR2, which in turn each provide regulated AC and DC power. Power from channel PWR1 provides power to both the primary and alternate BCC1s. Power from channel PWR2 provides backup power to both the primary and alternate BCC1s (as represented by dashed line). Furthermore, channel PWR1 provides operating power to controller 1A and its corresponding dual brake command processor and drivers 30. Similarly, channel PWR2 provides operating power to controller 1B and its corresponding dual brake command processor and drivers 30.

Thus, in the event one of the power supply channels PWR1 or PWR2 was to fail, operation of the EMAC 24 can be maintained with respect to one of the primary and alternate control channels. For example, if channel PWR1 was to fail, power to primary BCC1 would still be provided via channel PWR2. While controller 1A and its corresponding dual brake command processor and drivers 30 become disabled, thus rendering the corresponding actuators 18 of the primary control channel 24a disabled, the alternate control channel 24b would remain operational.

The EMAC 26 operates similarly to EMAC 24 in such regard, with the exception that EMAC 26 is powered by independent power source AC2. Thus, should power source AC1 fail, thereby disabling EMAC 24, EMAC 26 would remain operational. Conversely, should power source AC2 fail, EMAC 24 would still remain operational.

In accordance with the exemplary embodiment, primary control channel 24a controls four actuators 18, two on front left wheel 12 and two on front right wheel 14. Alternate control channel 24b controls four actuators 18, two on front left wheel 12 and two on front right wheel 14. Primary control channel 26a controls four actuators 18, two on rear left wheel 13 and two on rear right wheel 15. Alternate control channel 26b controls four actuators 18, two on rear left wheel 13 and two on rear right wheel 15.

In the event of a loss of one of the power channels (e.g., PWR1 or PWR2 of the EMAC 24), four actuators 18 associated with the disabled primary or alternate control channel will become disabled. As a result, twelve out of sixteen actuators 18 will remain operational so as to provide 75% full braking. By overdriving the remaining operational actuators 18 by 33%, for example, the braking system 10 can maintain 84% full braking. Meanwhile, antiskid control remains available via the operational BCC.

In the event of the loss of one of the independent power sources (e.g., AC1 or AC2), the corresponding EMAC (24 or 26) will be disabled. This results in eight out of sixteen actuators 18 remaining operational so as to provide at least 50% full braking, and more should overdriving of the operational actuators be employed. Meanwhile, antiskid control again remains available via the BCC of the operational EMAC.

Should a BCC fail in a primary or alternate control channel of an EMAC, 100% of full braking with antiskid control remains available via the BCC of the remaining control channel.

Should one of the actuators 18 fail, fifteen out of sixteen actuators would remain operational, making 94% of full braking available, and more by overdriving the remaining actuators. Should one of the wheel speed sensors fail for a given wheel, the BCC within the EMAC may substitute the wheel speed measurement for the other wheel on the same side of the aircraft as a reasonable estimate of the wheel speed. In either case, antiskid control may be maintained.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

What is claimed is:

1. An electromechanical braking system, comprising:
at least one brake system control unit (BSCU) for converting an input brake command signal into a brake clamp force command signal;
a first electromechanical actuator controller (EMAC) and a second electromechanical actuator controller (EMAC) configured to receive the brake clamp force command signal from the at least one BSCU and to convert the brake clamp force command signal to at least one electromechanical actuator drive control signal; and
at least one electromechanical actuator configured to receive the at least one drive control signal and to apply a brake clamp force to at least one wheel to be braked in response to the at least one drive control signal,
wherein the first EMAC and the second EMAC are configured to perform antiskid control in relation to the at least one wheel to be braked.

2. The braking system of claim 1, wherein the at least one wheel to be braked comprises a first pair of wheels and a second pair of wheels, the first EMAC is configured to provide brake control and antiskid control to a first wheel in each of the first and second pairs of wheels, and the second EMAC is configured to provide brake control and antiskid control to a second wheel in each of the first and second pairs of wheels.

3. The braking system of claim 2, wherein the first pair of wheels represents a left set of wheels on an aircraft, and the second pair of wheels represents a right set of wheels on the aircraft.

4. The braking system of claim 1, comprising at least one sensor for measuring wheel speed of the at least one wheel to be braked, and an output of the at least one sensor being provided to at least one of the first EMAC and the second EMAC independent of the at least one BSCU for purposes of performing the antiskid control.

5. The braking system of claim 1, wherein the first EMAC and the second EMAC each include internal redundancy for providing brake control and antiskid control.

6. The braking system of claim 5, wherein the at least one wheel to be braked comprises a first pair of wheels and a second pair of wheels, the first EMAC is configured to provide brake control and antiskid control to a first wheel in each of the first and second pairs of wheels, and the second EMAC is configured to provide brake control and antiskid control to a second wheel in each of the first and second pairs of wheels, and
wherein a primary channel within the first EMAC controls a first set of actuators on each of the first wheels in the first and second pairs of wheels, an alternate channel within the first EMAC controls a second set of actuators on each of the first wheels in the first and second pairs of wheels, a primary channel within the second EMAC controls a first set of actuators on each of the second wheels in the first and second pairs of wheels, and an alternate channel within the second EMAC controls a second set of actuators on each of the second wheels in the first and second pairs of wheels.

7. The braking system of claim 1, wherein the first EMAC and the second EMAC receive power from independent power sources.
